(19) United States
(12) Patent Application Publication
(10) Pub. No.: US 2020/0022516 A1
(43) Pub. Date: Jan. 23, 2020

(54) PAPER STRAW AND METHOD FOR MAKING THE SAME

(71) Applicant: TZU HUNG TSAI, TAICHUNG CITY (TW)

(72) Inventors: TZU HUNG TSAI, TAICHUNG CITY (TW); CHEN WEN WU, KAOHSIUNG CITY (TW)

(21) Appl. No.: 16/503,834

(22) Filed: Jul. 5, 2019

(30) Foreign Application Priority Data
Jul. 19, 2018 (TW) 107124887

(51) Int. Cl. A47G 21/18; B31F 1/00; B31F 1/36; B31F 7/00; C09D 5/16

(52) U.S. Cl. CPC A47G 21/18; B31F 1/0009; C09D 5/16; B31F 7/004; B31F 1/36

(57) ABSTRACT

A method for making a paper straw and includes a step of applying anti-bacterial and water-proof layer to both sides of a paper sheet; a step of flatting or scrolling the paper sheet to be round and tubular, and two sides of each paper sheet being overlapped to each other; a step of pressing and adhering the overlapped portion to form initial type of a paper straw; a step of drying the initial type of the paper straw to solidify the water-proof layer, and a step of cutting the initial type of the paper straw into multiple sections. The paper straw of the present invention is anti-bacterial, water-proof and is not deformed in liquid or beverage.

### BACKGROUND OF THE INVENTION

### 1. Fields of the Invention

The present invention relates to a method for making a paper straw, and more particularly, to a method for making a paper straw that includes a water-proof layer.

### 2. Descriptions of Related Art

The conventional straws are made of plastic which is now realized to become micro articles and different to be degraded. These micro plastic particles harm the environment and animals, and become a global problem. In order to reduce use of the plastic straws, paper-made straws are developed. However, the paper-made straws cannot last long in liquid or beverage. The conventional water-proof material such as PE, PP, PET and PAL cannot be used on the paper-made straws to achieve the purpose of water-proof.

The present invention intends to provide a method for making a paper straw which includes a water-proof layer and is friendly to the environment.

### SUMMARY OF THE INVENTION

The present invention relates to a method for making a paper straw, and the method comprising the follow steps:

a step of applying water-proof layer:

applying water-proof liquid to both sides of a paper sheet, the water-proof liquid including 8% to 30% weight percentage of Polyurethane copolymer, 8% to 30% weight percentage of Acrylates Copolymer, 8% to 9% weight percentage of carboxylic butadiene-styrene latex, OA % to 0.6% weight percentage of Sodium tripolyphosphate, 2% to 3% weight percentage of Propylene glycol, 3% to 5% weight percentage of Carbonic acid ammonium zirconium salt, and 25% to 60% weight percentage of Deionized water;

a step of forming:

the paper sheets being flattened or spirally scrolled by machine so as to be round and tubular, two sides of each paper sheet being overlapped to each other;

a step of adhering:

pressing the overlapped portion and using the water-proof layer to be adherent to form an initial type of a paper straw;

a step of drying:

drying the initial type of the paper straw to solidify the water-proof layer, and

a step of cutting:

cutting the initial type of the paper straw into multiple sections.

Preferably, the water-proof liquid further includes 1% to 7% weight percentage of Nano-Oxides.

Preferably, in the step of pressing the overlapped portion, a way of heat-pressing, high-frequency adhering or ultra-sonic adhering is used to press the overlapped portion.

Preferably, in the step of pressing the overlapped portion, the overlapped portion is adhered by way of single-point and continuous adhering, single-point and discontinuous adhering, or planar adhering along the overlapped portion.

Preferably, in the step of drying, the initial type of the paper straw is put in a drying box under 80 to 120 degrees Celsius to be dried.

The present invention also provides a paper straw which comprises a hollow tube having an overlapped portion which is formed by overlapped two sides of a paper sheet. Both sides of the hollow tube is are respectively applied by a water-proof layer which is formed by the dried water-proof liquid. An adhered portion is formed to the two overlapped sides of the hollow tube. The two overlapped sides of the hollow tube are adhered to each other by an adhesive layer which is formed by the two water-proof layers.

Preferably, the adhered portion is formed by way of heat-pressing adhering, high-frequency adhering or ultra-sonic adhering to adhere the overlapped portion by the two water-proof layers.

Preferably, the adhered portion is formed by way of single-point and continuous adhering, single-point and discontinuous adhering, or planar adhering along the overlapped portion.

The primary object of the present invention is to provide a method for making a paper straw, and the paper straw is anti-bacterial, water-proof and is not deformed in liquid or beverage.

Another object of the present invention is to provide a method for making a paper straw without use of the conventional water-proof material such as PE, PP, PET and PAL.

The advantages of the present invention are that the water-proof layer of the present invention makes the paper straw of the present invention be more tough and durable in liquid. The paper straw of the present invention is easily degraded.

The water-proof liquid of the present invention is anti-bacterial liquid which is added with Nano-Oxides so as to inhibit bacterial growth.

The paper strew of the present invention can be made in mass production with low cost.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of the method of the present invention;

FIG. 2 shows the ingredients of the water-proof liquid used in the method of the present invention;

FIG. 3 shows that the water-proof layers on both sides of the paper sheet;

FIG. 4 shows the end cross sectional view of the paper straw of the present invention;

FIG. 5 shows the ways of the adhering of the method of the present invention, and

FIG. 6 shows perspective views of different types of paper straws of the present invention.

### DETAILED DESCRIPTION OF THE PREFERRED EMBODIMENT

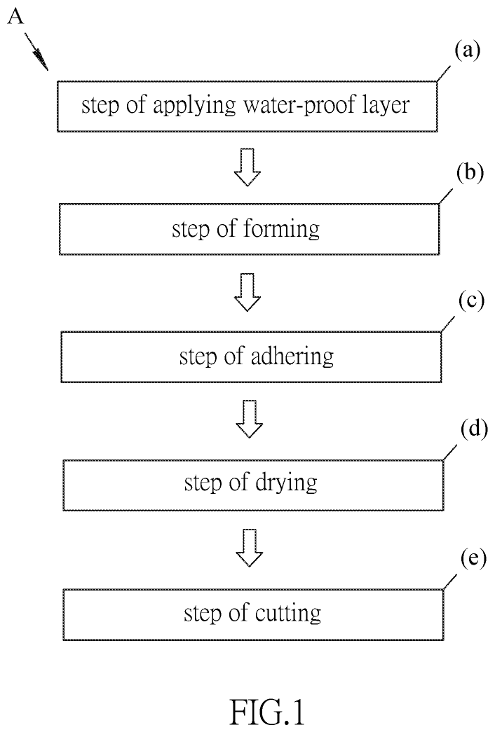

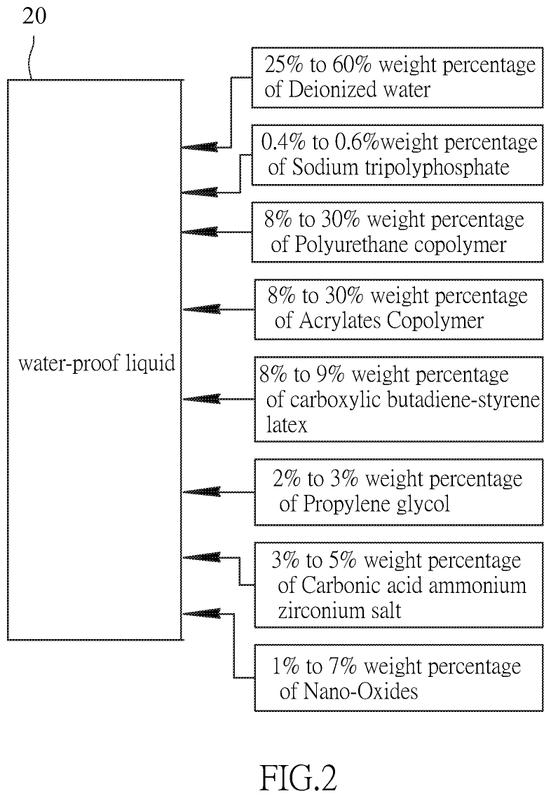

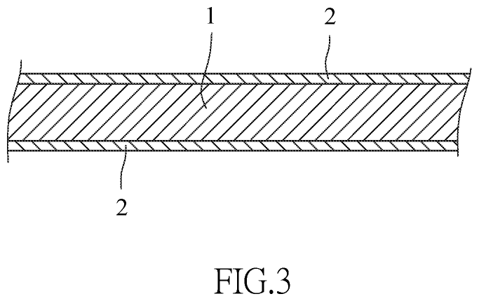

Referring to FIGS. 1 to 5, the method “A” for making a paper straw of the present invention comprises the following steps:

a step “a” of applying water-proof layer:

applying water-proof liquid 20 to both sides of a paper sheet 1, the water-proof liquid 20 including 8% to 30% weight percentage of Polyurethane copolymer, 8% to 30% weight percentage of Acrylates Copolymer, 8% to 9% weight percentage of carboxylic butadiene-styrene latex, 0.4% to 0.6% weight percentage of Sodium tripolyphosphate, 2% to 3% weight percentage of Propylene glycol, 3% to 5% weight percentage of Carbonic acid ammonium zirconium salt, 1% to 7% weight percentage of Nano-Oxides, and 25% to 60% weight percentage of Deionized water;

a step “b” of forming:

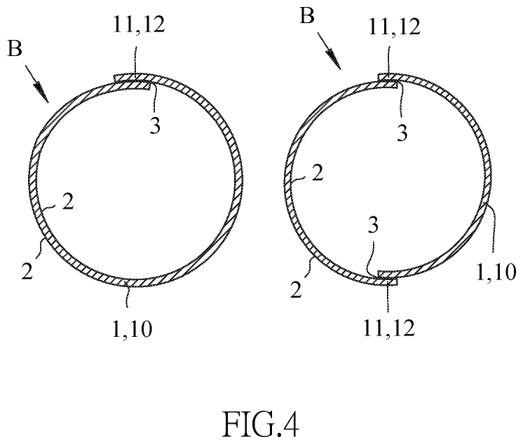

the paper sheets 1 being flattened or spirally scrolled by machine, and the paper sheet 1 is processed by a conical board so as to be round and tubular, two sides of each paper sheet 1 being overlapped to each other as shown in FIG. 4, when only one paper sheet is processed, then only one overlapped portion 11 is formed, when multiple paper sheets are processed, then two overlapped portions 11 are formed;

a step “c” of adhering:

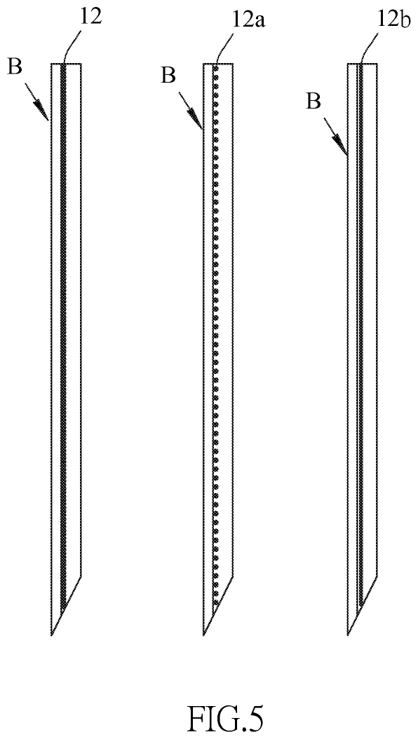

pressing the overlapped portion and using the water-proof layer 2 to be adherent 3 to form an initial type of a paper straw, a way of heat-pressing adhering, high-frequency adhering or ultra-sonic adhering being used to press the overlapped portion, the overlapped portion being adhered by way of single-point and continuous adhering 12 to form the single-point and continuous adhered portion 12a, single-point and discontinuous adhering to form the single-point and discontinuous adhered portion 12b, or planar adhering along the overlapped portion to form the planar adhered portion 12c as shown in FIG. 5;

a step “d” of drying:

drying the initial type of the paper straw to solidify the water-proof layer 2, the initial type of the paper straw being put in a drying box under 80 to 120 degrees Celsius to be dried, and

a step “e” of cutting:

cutting the initial type of the paper straw into multiple sections to form the paper straws “B”.

The paper straw “B” made by the method “A” of the present invention comprises a hollow tube 10 having an overlapped portion 11 which is formed by overlapped two sides of a paper sheet 1. Each of two sides of the hollow tube 10 has a water-proof layer 2 applied thereto, wherein the water-proof layers 2 each are formed by dried water-proof liquid 20. An adhered portion 12 is formed to the two overlapped sides of the hollow tube 10, wherein the two overlapped sides of the hollow tube 10 is adhered to each other by an adhesive layer 3 which is formed by the two water-proof layers 2. The adhered portion 12 is formed by way of heat-pressing, high-frequency adhering or ultra-sonic adhering to adhere the overlapped portion by the two water-proof layers 2. The adhered portion 12 is formed by way of single-point and continuous adhering to form the single-point and continuous adhered portion 12a, single-point and discontinuous adhering to form the single-point and discontinuous adhered portion 12b, or planar adhering along the overlapped portion to form the planar adhered portion 12c.

The water-proof layer 2 of the present invention is used as the adherent, and the overlapped portion 11 of the paper straw is pressed by way of heat-pressing, high-frequency adhering or ultra-sonic adhering so that the paper straw of the present invention is strong, durable and is not deformed in liquid. The water-proof liquid 20 is anti-bacterial liquid to inhibit bacterial growth.

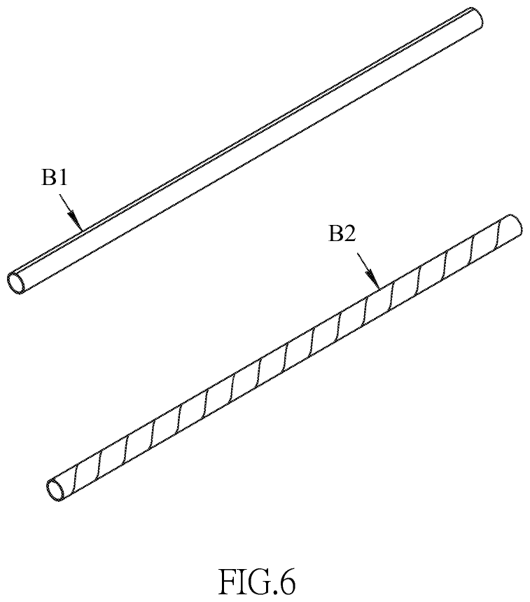

As shown in FIG. 6, the paper straws “B” can be straight pull type paper straws B1 and spiral type paper straws B2. The straight pull type paper straws B1 are made by pulling one or more paper sheets 1, and adhering the overlapped portions 11 by way of single-point and continuous adhering, single-point, discontinuous adhering, high-frequency adhering or ultra-sonic adhering. The spiral type paper straws B2 are made by spirally scrolling one or more paper sheets 1, and adhering the overlapped portions by way of single-point and continuous adhering, single-point, discontinuous adhering, high-frequency adhering or ultra-sonic adhering.

While we have shown and described the embodiment in accordance with the present invention, it should be clear to those skilled in the art that further embodiments may be made without departing from the scope of the present invention.

What is claimed is:

1. A method for making a paper straw, comprising:
a step of applying water-proof layer:
applying water-proof liquid to both sides of a paper sheet, the water-proof liquid including 8% to 30% weight percentage of Polyurethane copolymer, 8% to 30% weight percentage of Acrylates Copolymer, 8% to 9% weight percentage of carboxylic butadiene-styrene latex, 0.4% to 0.6% weight percentage of Sodium tripolyphosphate, 2% to 3% weight percentage of Propylene glycol, 3% to 5% weight percentage of Carbonic acid ammonium zirconium salt, and 25% to 60% weight percentage of Deionized water;
a step of forming:
the paper sheets being flattened or spirally scrolled by machine so as to be round and tubular, two sides of each paper sheet being overlapped to each other;
a step of adhering:
pressing the overlapped portion and using the water-proof layer to be adherent to form an initial type of a paper straw;
a step of drying:
drying the initial type of the paper straw to solidify the water-proof layer, and
a step of cutting:
cutting the initial type of the paper straw into multiple sections.

2. The method for making a paper straw as claimed in claim 1, wherein the water-proof liquid further includes 1% to 7% weight percentage of Nano-Oxides.

3. The method for making a paper straw as claimed in claim 1, wherein in the step of pressing the overlapped portion, a way of heat-pressing, high-frequency adhering or ultra-sonic adhering is used to press the overlapped portion.

4. The method for making a paper straw as claimed in claim 3, wherein in the step of pressing the overlapped portion, the overlapped portion is adhered by way of single-point and continuous adhering, single-point and discontinuous adhering, or planar adhering along the overlapped portion.

5. The method for making a paper straw as claimed in claim 4, wherein in the step of drying, the initial type of the paper straw is put in a drying box under 80 to 120 degrees Celsius to be dried.

6. A paper straw comprising:
a hollow tube having an overlapped portion which is formed by overlapped two sides of a paper sheet;
each of two sides of the hollow tube having a water-proof layer applied thereto, the water-proof layers each being formed by dried water-proof liquid, and
an adhered portion being formed to the two overlapped sides of the hollow tube, the two overlapped sides of the hollow tube being adhered to each other by an adhesive layer which is formed by the two water-proof layers.

7. The paper straw as claimed in claim 6, wherein the adhered portion is formed by way of heat-pressing, high-frequency adhering or ultra-sonic adhering to adhere the overlapped portion by the two water-proof layers.

8. The paper straw as claimed in claim 7, wherein the adhered portion is formed by way of single-point and continuous adhering, single-point and discontinuous adhering, or planar adhering along the overlapped portion.
